(19) United States
(12) Patent Application Publication
(10) Pub. No.: US 2011/0116103 A1
(43) Pub. Date: May 19, 2011

(54) METHOD FOR DETECTING ALIGNMENT OF A DOOR SURROUND STRUCTURE

(76) Inventors: Aik Puck Leong, Singapore (SG); Meng Liang Ang, Singapore (SG); Wern Chiat Adrian Teng, Singapore (SG); Tiong Teck Lin, Singapore (SG)

(21) Appl. No.: 12/949,688

(22) Filed: Nov. 18, 2010

(30) Foreign Application Priority Data
Nov. 19, 2009 (SG) 200907693.6

(51) Int. Cl. G01B 11/14

(52) U.S. Cl. 356/620

(57) ABSTRACT

A method for detecting alignment of a door surround structure. The method comprising the steps of mounting a light source to one side of the door surround structure; mounting a target to an opposite side of the door surround structure, the target comprising a marking and configured to receive a light beam from the light source; and determining a distance between the marking and the light beam on the target; wherein an alignment is detected based on the distance between the marking and the light beam on the target.

### FIELD OF INVENTION

The present invention relates broadly to a method for detecting alignment of a door surround structure, to a kit of parts for detecting alignment of a door surround structure, and to a device for mounting a light source to a door surround structure.

### BACKGROUND

In a life-cycle of a passenger airplane, the airplane may be converted to a freighter airplane before retiring to maximize its utility. For a Passenger to Freighter (PTF) conversion, a section of the existing aircraft fuselage structure is usually removed and replaced by a reinforced fuselage section (i.e. Door Surround Structure or DSS) with a door opening for e.g. cargo door or crew entry door installation. It will be appreciated that the alignment of the door surround structure is critical as any out of design tolerance misalignment can potentially result in a door mismatch with the opening, and a failure of the integration efforts.

The door surround structure and the doors, however, are typically manufactured and assembled separately at different facilities for e.g. strategic or economic consideration. This has increased the risk of alignment issues for the door and door surround structure integration because any mismatch is detected only after the door surround structure has been integrated onto the existing airplane fuselage structure and difficulties are subsequently encountered in rigging the door fully based on a defined procedure.

The remedy for any mismatch may require massive engineering efforts to re-design the door surround structure and/or the door components to re-align the door to the door surround structure opening, or major rework to rectify the door surround structure to meet the interface requirements. In some serious cases, the entire door surround structure may need to be replaced with a new door surround structure. The removal and re-installation of the new door surround structure is fraught with further risks of e.g. incurring workmanship errors that may require extensive airplane repairs and damage tolerance analysis to substantiate the airworthiness of airplane.

Furthermore, even though the above difficulties can be resolved technically, there may be future airplane maintenance and logistic issues with unique parts due to such rectification.

To detect the door surround structure and door mismatch issue earlier, one can perform measurement of the door opening on the door surround structure to ensure the design requirements are met. In one existing approach, an imaging system is used to scan the door surround structure and the output from the scan is converted into 3-dimensional model data using e.g. Computer-Aided Design (CAD) software. The imaging system of the above approach is generally large and complex as additional equipment is needed to move the scanning device along at least the width and height of the door opening. Also, skilled workmen are required to perform the measurements and to transfer the measurements to a CAD system for analysis in order to confirm whether the door opening meets the design requirements. Thus, the above approach is very expensive. Furthermore, no movement of the airplane is allowed while the measurements are being performed, and airplane is required to be in a leveled condition for accurate measurements. While professional imaging equipment and services are available in the market to help to reduce the equipment's initial capital investment, these services are not only costly but also can affect the airplane modification schedule.

In another existing approach, a dummy door is installed on the door surround structure to simulate an actual door, for checking alignment of the door opening. While fabrication of a dummy door for a typical frame structure is feasible, the dummy door needs to be substantially the same as the actual door in terms of dimensions, stiffness, etc in order to accurately simulate the actual door. In addition, significant time and effort are needed to install the dummy door onto the door surround structure. This method may also pose additional hazardous conditions due to the weight and size of the dummy door, as a typical cargo door can be as big as 140 inches (in.) (width)×84 in. (height) (or about 3.5 m×2.1 m) in dimension. Warpage of the dummy door is also one of the concerns in the long term due to the weight of the dummy door that can result in mishandling. This approach is therefore impractical as a long-term solution.

A need therefore exists to provide a method that seeks to minimize at least one of the above problems.

### SUMMARY

In accordance with a first aspect of the present invention, there is provided a method for detecting alignment of a door surround structure, the method comprising the steps of:

mounting a light source on one side of the door surround structure;

mounting a target on an opposite side of the door surround structure, the target comprising a marking and configured to receive a light beam from the light source; and

determining a distance between the marking and the light beam on the target;

wherein an alignment is detected based on the distance between the marking and the light beam on the target.

The light source may comprise a laser.

The mounting of the light source on one side of the door surround structure may comprise mounting the light source to one or more hinges disposed on said one side of the door surround structure.

The light source may be rotatably mounted to the one or more hinges.

The method may further comprise:

positioning the light source at a first distance horizontally from a first reference edge on the one side; and

positioning the marking at a second distance horizontally from a second reference edge on the opposite side, wherein the first distance is substantially equal to the second distance.

The positioning of the light source may comprise first mounting a source base plate on which the light source is mounted to the one or more hinges and then adjusting the light source relative to the source base plate.

The positioning of the marking may comprise first mounting a target base plate on which an adjustable target plate is mounted to the opposite side of the door surround structure and then adjusting the target plate relative to the target base plate.

The method may further comprise adjusting a direction of the light beam along a plane perpendicular to an axis of the hinges for positioning the light beam on the target.

The adjusting of the direction of the light beam may comprise adjusting a spacer element coupled between the light source and a stopper surface of the one side of the door surround structure.

In accordance with a second aspect of the present invention, there is provided a kit of parts for detecting alignment of a door surround structure, the kit of parts comprising:

a light source adapted to be mounted to one side of the door surround structure; and

a target adapted to be mounted to an opposite side of the door surround structure, the target comprising a marking and configured to receive a light beam from the light source;

wherein an alignment is detected based on a distance between the marking and the light beam on the target.

The light source may comprise a laser.

The light source may be adapted for mounting to one or more hinges disposed on said one side of the door surround structure.

The light source may be adapted for rotatable mounting to the one or more hinges.

The kit of parts may further comprise a source base plate on which the light source may be adjustably mounted for positioning the light source.

The target may comprise a target base plate on which an adjustable target plate comprising the marking may be mounted for positioning the marking.

The kit of parts may further comprise a spacer element adapted for coupling between the light source and a stopper surface of the one side of the door surround structure, wherein the spacer element may be adjustable for adjusting the direction of the light beam.

In accordance with a third aspect of the present invention, there is provided a device for mounting a light source to a door surround structure, the device comprising:

a source base plate on which the light source is mountable and adapted to be mounted to one or more hinges of the door surround structure; and

a spacer element coupled to the source base plate and configured to abut a stopper surface of the door surround structure for adjusting a direction of a light beam emitted from the light source.

The light source may comprise a laser.

The source base plate may be adapted for rotatable mounting to the one or more hinges.

The light source may be adjustable relative to the source base plate for positioning the light source.

The direction of the light beam emitted from the light source may be adjustable along a plane perpendicular to an axis of the hinges.

The spacer element may adjust an angle between the source base plate and the stopper surface for adjusting the direction of a light beam emitted from the light source.

### BRIEF DESCRIPTION OF THE DRAWINGS

Embodiments of the invention will be better understood and readily apparent, to one of ordinary skill in the art from the following written description, by way of example only, and in conjunction with the drawings, in which:

FIG. 1A shows a perspective view of an airplane having a section removed from its fuselage for fitting a door surround structure according to an example embodiment.

FIG. 1B shows a side view of the airplane of FIG. 1A according to an example embodiment.

FIG. 1C shows a sectional view of a fuselage of the airplane of FIG. 1B along line A-A according to an example embodiment.

FIG. 2A shows a front view as seen from a side of an aircraft of a door surround structure according to an example embodiment.

FIG. 2B shows a cross-sectional view of the door surround structure of FIG. 2A.

FIG. 3 shows a perspective view of a door opening of the door surround structure of FIG. 2A having an alignment apparatus installed thereon according to an example embodiment.

FIG. 4 shows a sectional view of a source of the alignment apparatus of FIG. 3 about a plane perpendicular to the axis of the fuselage.

FIG. 5A shows a plan view of a target of FIG. 3 according to an example embodiment.

FIG. 5B shows an elevated view of the target of FIG. 5A.

FIGS. 6A-6B show schematic diagrams illustrating example scenarios and respective misalignment detection results using the apparatus of the example embodiment.

FIG. 7 shows a flow chart illustrating a method for detecting alignment of a door surround structure according to an example embodiment.

### DETAILED DESCRIPTION

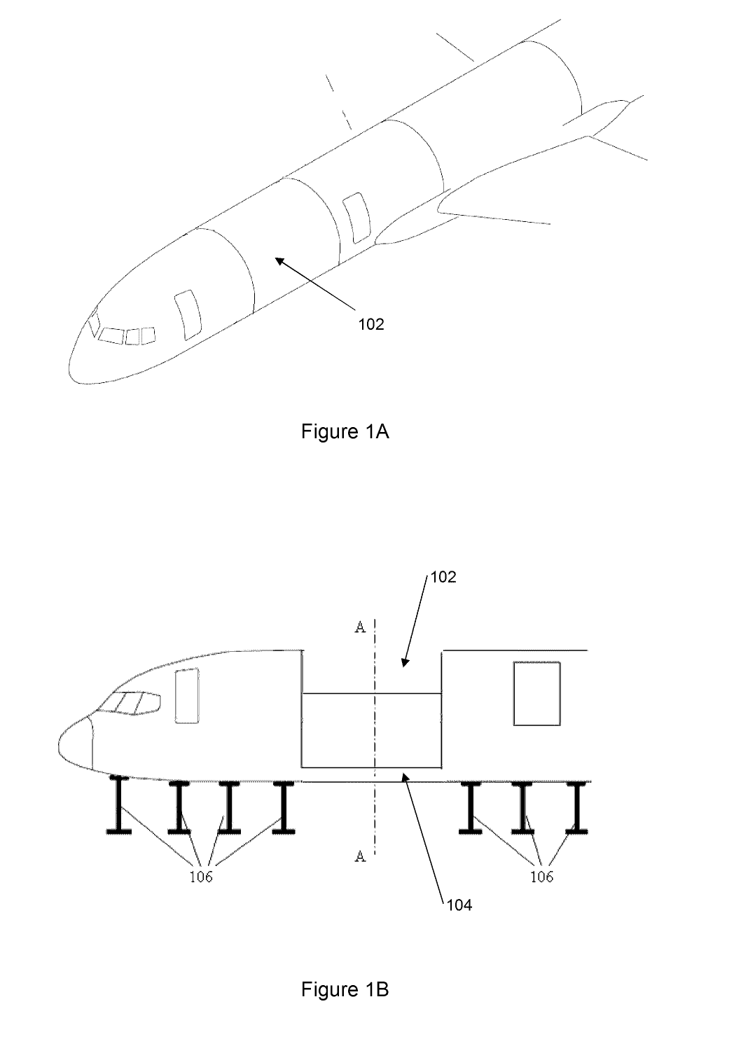

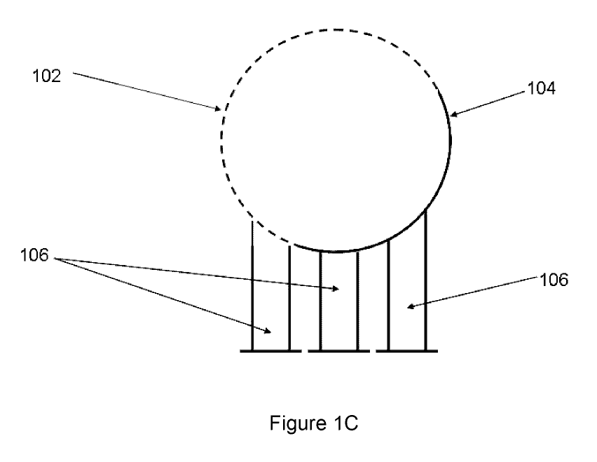

FIG. 1A shows a perspective view of an airplane having a section 102 removed from its fuselage for fitting a door surround structure according to an example embodiment. FIG. 1B shows a side view of the airplane of FIG. 1A according to an example embodiment. FIG. 1C shows a sectional view of a fuselage of the airplane of FIG. 1B along line A-A according to an example embodiment.

As can be seen from FIGS. 1A-1B, section 102 is disposed between a front door and a middle door of the airplane in the example embodiment. In addition, as can be seen from FIG. 1C, a remaining section 104 comprises about less than half of the fuselage circumference. Supporting means, e.g. jacks 106, are provided in the example embodiments for supporting the airplane while work is being carried out.

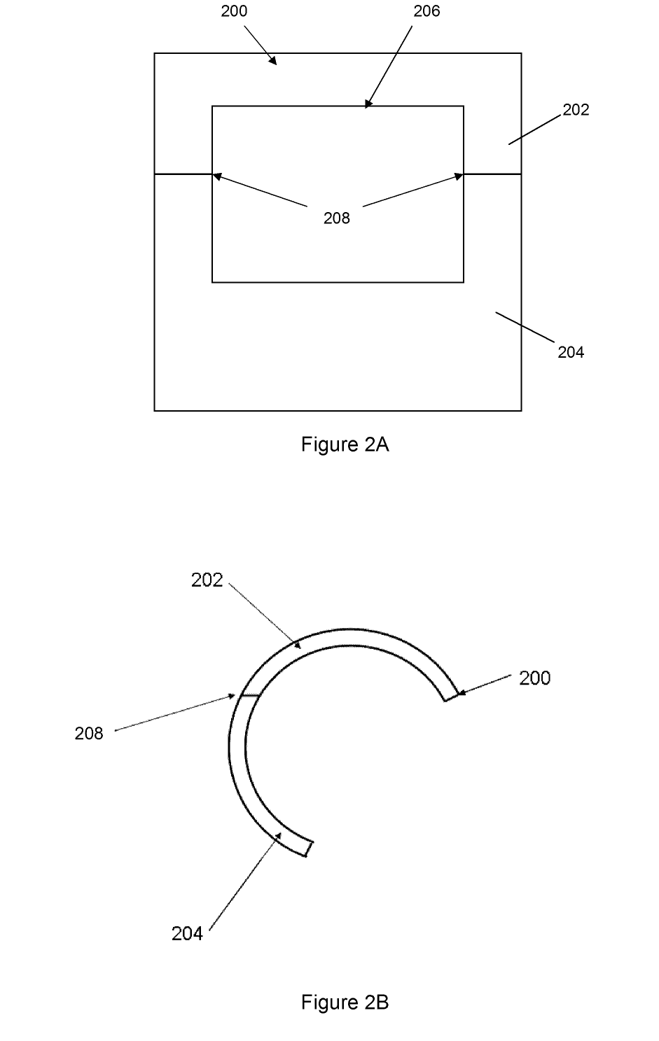

FIG. 2A shows a front view as seen from a side of an aircraft of a door surround structure 200 according to an example embodiment. FIG. 2B shows a cross-sectional view of the door surround structure 200 of FIG. 2A. The door surround structure 200 is usually made of a skin layer and support elements, e.g. stringers and frame, as understood by a person skilled in the relevant art. The door surround structure 200 comprises an upper half 202 and a lower half 204 which define a hollow door opening 206 for mounting a door (not shown) thereon. The upper half 202 mates with the lower half 204 at interface 208 in the example embodiment. As mentioned above, the door surround structure 200 replaces the removed section 102 (FIG. 1), which comprises approximately two-thirds of the fuselage circumference. The width of the door surround structure 200 is typically about 220 in (5.6 m), and the weight is about 500 kg, excluding the door, which is approximately one-third of the weight of the door surround structure 200.

As discussed above, the door surround structure 200 may be built separately, e.g. on a support jig. Once ready, the door surround structure 200 is hoisted, e.g. by using an overhead mechanical equipment (OHME), and positioned onto an airplane that has a section of it fuselage removed, such as the one shown in FIG. 1A. As will be appreciated by a person skilled in the art, the OHME is capable of shifting the door surround structure 200 linearly as well as rotationally about an exterior of the fuselage for adjusting its position and orientation. After a good fit between the door surround structure 200 and the fuselage structure is achieved, temporary fastening means are applied to secure the door surround structure 200 onto the fuselage. A detection of any misalignment between the upper half 202 and the lower half 204 is carried out before permanent fastening means, e.g. rivets, are applied.

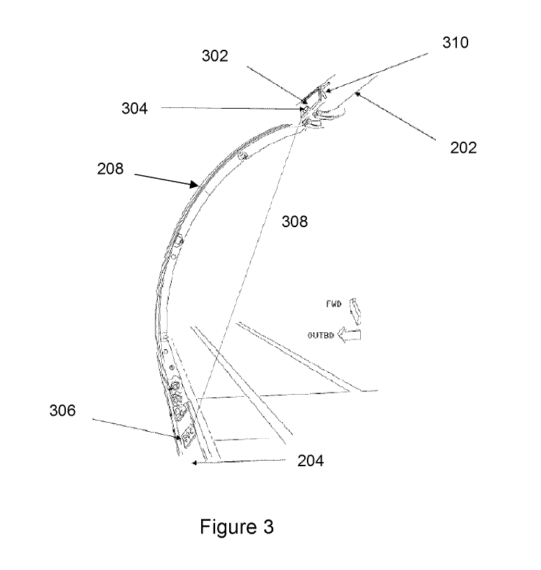

FIG. 3 shows a perspective view of a door opening 206 of the door surround structure 200 of FIG. 2A having an alignment apparatus installed thereon according to an example embodiment. The alignment apparatus comprises a source 302 and a target 306. The source 302 comprises a laser 304 capable of emitting a substantially narrow laser beam 308 onto the target 306. The source 302 is rotatably mounted to a door hinge 310 on one side, e.g. the upper half 202, of the door surround structure 200 (FIG. 2), while the target 306 is mounted to a latch area on an opposite side, e.g. the lower half 204, of the door surround structure 200.

As described above, after the door surround structure is temporarily secured to the fuselage structure, the source 302 and target 306 of the alignment apparatus are mounted to their respective positions on the two halves of the door surround structure 200. In the example embodiment, by measuring the position of the laser beam 308 on the target 306, any misalignment, e.g. linear or angular, can advantageously be determined, investigated and corrected before the door surround structure 200 is permanently integrated into the fuselage structure.

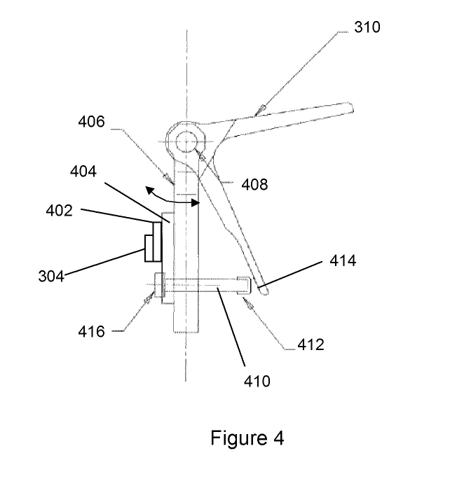

FIG. 4 shows a sectional view of the source 302 of the alignment apparatus of FIG. 3 about a plane perpendicular to the axis of the fuselage.

As can be seen in FIGS. 3 and 4, the source 302 in the example embodiment comprises a laser 304 fixedly mounted to a laser holder 402. The laser holder 402 is mounted to a linear adjustment mechanism, e.g. guided slide 404, configured to allow movement of the laser holder 402 only in a direction parallel to the axis of the fuselage, for fine positional calibration of the laser holder 402. The guided slide 404 is fastened using e.g. screws to prevent movement of the laser holder 402 during use. A fixed base of the guided slide 404 is mounted to a plate 406 using e.g. screws or bolts. The plate 406 comprises a plurality of hinge lobes (not shown) configured to engage with selected hinge lobes (not shown) of the door hinge 310 on the door surround structure. A hinge pin 408 is inserted in the example embodiment through holes on hinge lobes to support the plate 406 and to rotatably mount the plate 406 to the door hinge 310.

By having the laser 304 mounted to the plate 406, which is rotatably mounted to the door hinge 310, the direction of the laser 304 in a plane perpendicular to an axis of the hinge 310 can be preferably adjusted to ensure that the laser beam strikes the target 306 (FIG. 3). In addition, the apparatus according to the example embodiment can advantageously simulate the actual rotational movement of the door. Furthermore, the apparatus according to the example embodiment can be advantageously used not only with a particular door surround structure, but also other structures having hinges.

It will be appreciated that, as the door hinge 310 is fixed with respect to the door surround structure, a distance d₁ from the laser 304 to a reference edge on the upper half of the door surround structure along a direction parallel to the axis of the fuselage is predetermined. The hinge pin 408 preferably has a diameter that is close-fit with the diameters of the through holes on hinge lobes in the example embodiment such that free rotational movement of the plate 406 about the hinge pin 408 is minimized. In addition, a width of the hinge lobes on the plate 406 is preferably approximately equal to a gap between the hinge lobes on the door hinge in the example embodiment such that lateral movement of the plate 406 (i.e. in a direction parallel to the axis of the fuselage) is advantageously minimized. Thus, the position of the laser 304 and the laser beam 308 (FIG. 3) at any time is advantageously precise and stable.

Further, as illustrated in FIG. 4, a spacer element, e.g. a cap screw 410, is provided in the example embodiment for adjusting the direction of the laser beam 308 along a plane perpendicular to the axis of the hinge 310. The cap screw 410 comprises a distal end 412 abutting a stopper surface 414 on the door hinge 310. The distal end 412 is preferably enclosed in a resilient material, e.g. Teflon, rubber or plastic, for reducing or minimizing abrasion between the distal end 412 and the door hinge 310. The cap screw 410 is rotationally coupled to the plate 406 via e.g. threads (not shown) such that by turning e.g. a cap or knob at a proximal end 416 of the cap screw 410, an angle between the plate 406 and the fixed door hinge 310 is adjusted in the example embodiment. As a result, an elevation of the laser 304, hence the direction of the laser beam 308, can be adjusted to ensure that the laser beam strikes the target 306 (FIG. 3).

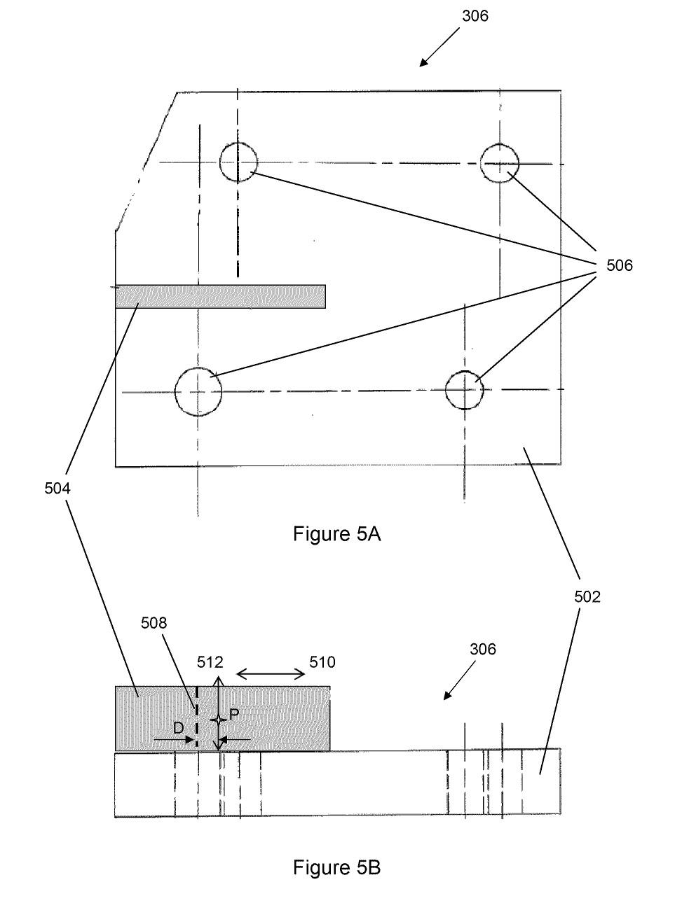

FIG. 5A shows a plan view of the target 306 of FIG. 3 according to an example embodiment. FIG. 5B shows an elevated view of the target 306 of FIG. 5A.

As shown in FIGS. 5A-5B, the target 306 comprises a base plate 502 and a target plate 504 which is disposed substantially perpendicular to the base plate 502 in the example embodiment. The target plate 504 is linearly adjustable along a direction parallel to the axis of the fuselage. A plurality of through holes 506 are provided on the base plate 502. The arrangement of through holes 506 on the base plate 502 in the example embodiment matches with the arrangement of respective holes provided on the latch area on the lower half of the door surround structure. The base plate 502 is secured to the latch area using fastening means, e.g. pins or bolts, that run through the holes 506.

The target plate 504 comprises a marking 508, e.g. a straight line perpendicular to the axis of the fuselage, clearly drawn on one of its faces in the example embodiment. The distance between the marking 508 and the through holes 506 along a direction 510 parallel to the axis of the fuselage is pre-determined. As through holes 506 are aligned with respective holes provided on the lower half of the door surround structure, the distance d₂ from the marking 508 to a reference edge on the lower half of the door surround structure along direction 510 is predetermined. The distance d₂ is preferably approximately equal to the distance d₁ in the example embodiment, that is, the laser beam is expected to strike the target plate 504 approximately at a point along the marking 508.

As described above with respect to FIG. 4, a cap screw 410 (FIG. 4) is provided to adjust the direction of the laser beam. In the example embodiment, as the laser is fixed relative to direction 510, a point P on the target plate 504 where the laser beam strikes can only be adjusted along a direction 512 that is parallel to the marking 508. Point P can be on either side of the marking 508, depending on the relative positions of the laser and the marking 508.

A distance D between point P and the marking 508 is determined in the example embodiment using a measuring instrument, e.g. a vernier calliper. If the distance D is within a threshold (e.g. design tolerance), the door surround structure is considered aligned in the example embodiment, and permanent fastening of the door surround structure to the fuselage structure is carried out. If the distance D is greater than the design tolerance, the door surround structure is considered not aligned in the example embodiment, and actions are taken to investigate and correct the misalignment.

In an alternate embodiment, a target zone (not shown) is provided on the target plate 504 based on the design tolerance, e.g. by marking a left limit and a right limit in the direction 510. If the laser beam falls within the target zone, the door surround structure is considered aligned in the alternate embodiment, and permanent fastening of the door surround structure to the fuselage structure is carried out. If the laser beam falls outside of the target zone, the door surround structure is considered not aligned in the alternate embodiment, and actions are taken to investigate and correct the misalignment.

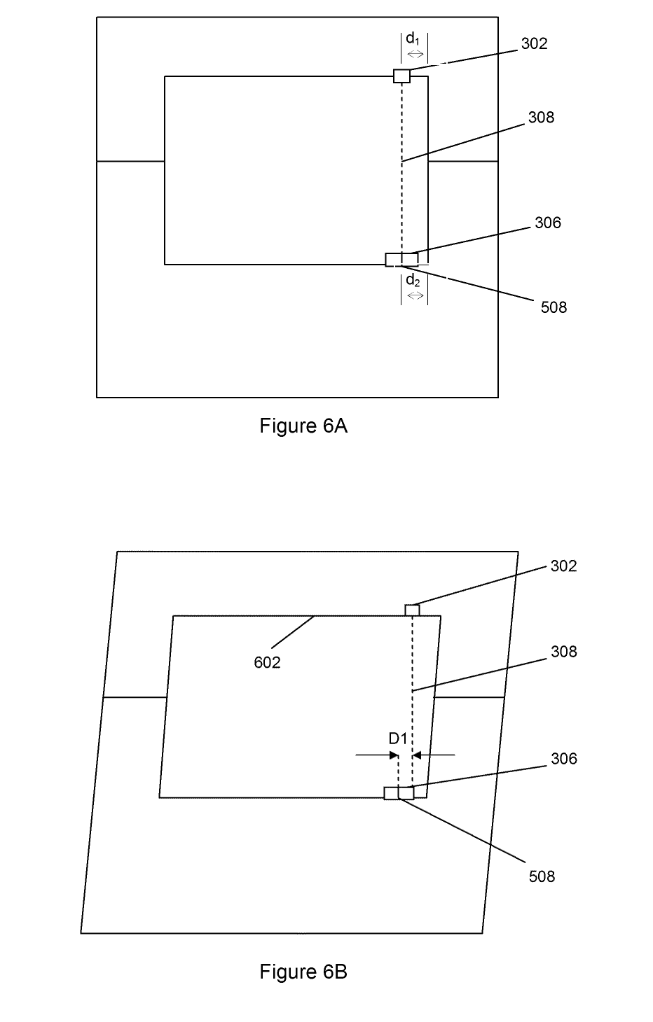

FIGS. 6A-6B show schematic diagrams illustrating example scenarios and respective misalignment detection results using the apparatus of the example embodiment.

In FIG. 6A, the upper half and the lower half of the door surround structure are substantially perfectly aligned. Thus, the laser beam 308 from the source 302 on the upper half strikes the target 306 on the lower half substantially along the marking 508.

In FIG. 6B, one or both halves of the door surround structure are built with slanted edges. Thus, as the laser beam 308 from the source 302 travels in a direction perpendicular to edge 602 on the upper half of the door surround structure, the laser beam strikes the target 306 on the lower half at a distance D1 from the marking 508, where D1 is greater than the design tolerance.

In the example embodiment, after the door surround structure is considered aligned, permanent fastening means, e.g. rivets, are applied to secure the door surround structure to the fuselage structure. In addition, support elements, e.g. stringers and frames, on the door surround structure are spliced with respective support elements on the fuselage structure using e.g. rivets, thereby integrating the door surround structure to the fuselage structure. A door, which may be built separately from the door surround structure, is then hoisted to a door opening 206 (FIG. 2) on the integrated door surround structure using a hoisting means, e.g. an OHME. The position and orientation of the door with respect to the door opening 206 is adjusted before the door is secured to the door hinge 310 (FIG. 3) on the door surround structure. In the example embodiment, as the upper half and the lower half of the door surround structure are advantageously aligned, the door is able to fit to the door opening 206 without interference or gap.

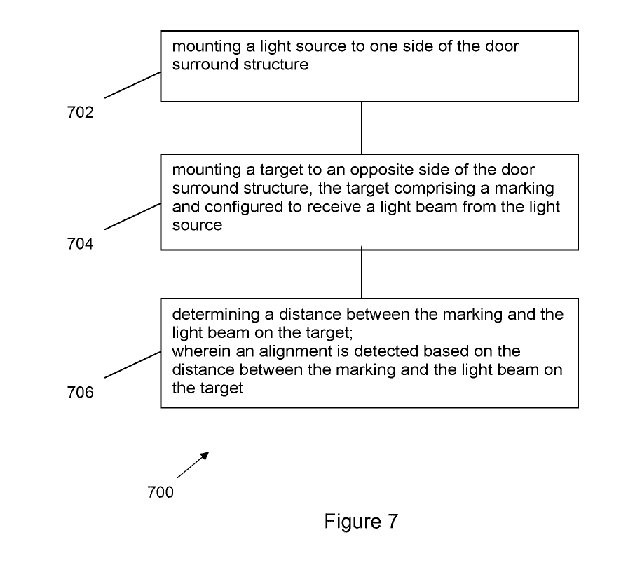

FIG. 7 shows a flow chart 700 illustrating a method for detecting alignment of a door surround structure. At step 702, a light source is mounted to one side of the door surround structure. At step 704, a target is mounted to an opposite side of the door surround structure, the target comprising a marking and configured to receive a light beam from the light source. At step 706, a distance between the marking and the light beam on the target is determined; wherein an alignment is detected based on the distance between the marking and the light beam on the target.

The alignment apparatus and method according to the example embodiment can have significant advantages over the existing approaches. Compared with the conventional imaging system, which is generally large, complex and expensive, the alignment apparatus of the present invention is advantageously significantly cheaper. In addition, the installation and operation of the apparatus are preferably faster than the existing approaches. For example, airplane levelling and restriction for mechanics working on airplane are not necessary; thus airplane delivery schedule and modification work flow are advantageously not affected. Also, the alignment apparatus and method of the example embodiment are relatively easy to use. Alignment checking in the example embodiment is carried out by measuring the distance between the laser beam spot on target plate and the marking on the target plate. Thus, no skilled workman for data reduction and further CAD analysis are preferably necessary and the alignment result is available almost instantly.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for detecting alignment of a door surround structure, the method comprising the steps of:
mounting a light source to one side of the door surround structure;
mounting a target to an opposite side of the door surround structure, the target comprising a marking and configured to receive a light beam from the light source; and
determining a distance between the marking and the light beam on the target;
wherein an alignment is detected based on the distance between the marking and the light beam on the target.

2. The method as claimed in claim 1, wherein the light source comprises a laser.

3. The method as claimed in claim 1, wherein mounting the light source to one side of the door surround structure comprises mounting the light source to one or more hinges disposed on said one side of the door surround structure.

4. The method as claimed in claim 3, wherein the light source is rotatably mounted to the one or more hinges.

5. The method as claimed in claim 3, further comprising:
positioning the light source at a first distance horizontally from a first reference edge on the one side; and
positioning the marking at a second distance horizontally from a second reference edge on the opposite side, wherein the first distance is substantially equal to the second distance.

6. The method as claimed in claim 5, wherein positioning the light source comprises first mounting a source base plate on which the light source is mounted to the one or more hinges and then adjusting the light source relative to the source base plate.

7. The method as claimed in claim 5, wherein positioning the marking comprises first mounting a target base plate on which an adjustable target plate is mounted to the opposite side of the door surround structure and then adjusting the target plate relative to the target base plate.

8. The method as claimed in claim 3, further comprising adjusting a direction of the light beam along a plane perpendicular to an axis of the hinges for positioning the light beam on the target.

9. The method as claimed in claim 8, wherein adjusting the direction of the light beam comprises adjusting a spacer element coupled between the light source and a stopper surface of the one side of the door surround structure.

10. A kit of parts for detecting alignment of a door surround structure, the kit of parts comprising:
a light source adapted to be mounted to one side of the door surround structure; and
a target adapted to be mounted to an opposite side of the door surround structure, the target comprising a marking and configured to receive a light beam from the light source;
wherein an alignment is detected based on a distance between the marking and the light beam on the target.

11. The kit of parts as claimed in claim 10, wherein the light source comprises a laser.

12. The kit of parts as claimed in claim 10, wherein the light source is adapted for mounting to one or more hinges disposed on said one side of the door surround structure.

13. The kit of parts as claimed in claim 12, wherein the light source is adapted for rotatable mounting to the one or more hinges.

14. The kit of parts as claimed in claim 10, further comprising a source base plate on which the light source is adjustably mounted for positioning the light source.

15. The kit of parts as claimed in claim 14, wherein the target comprises a target base plate on which an adjustable target plate comprising the marking is mounted for positioning the marking.

16. The kit of parts as claimed in claim 10, further comprising a spacer element adapted for coupling between the light source and a stopper surface of the one side of the door surround structure, wherein the spacer element is adjustable for adjusting the direction of the light beam.

17. A device for mounting a light source to a door surround structure, the device comprising:
a source base plate on which the light source is mountable and adapted to be mounted to one or more hinges of the door surround structure; and
a spacer element coupled to the source base plate and configured to abut a stopper surface of the door surround structure for adjusting a direction of a light beam emitted from the light source.

18. The device as claimed in claim 18, wherein the light source comprises a laser.

19. The device as claimed in claim 17, wherein the source base plate is adapted for rotatable mounting to the one or more hinges.

20. The device as claimed in claim 17, wherein the light source is adjustable relative to the source base plate for positioning the light source.

21. The device as claimed in claim 17, wherein the direction of the light beam emitted from the light source is adjustable along a plane perpendicular to an axis of the hinges.

22. The device as claimed in claim 21, wherein the spacer element adjusts an angle between the source base plate and the stopper surface for adjusting the direction of a light beam emitted from the light source.
